(19) United States
(12) Patent Application Publication
(10) Pub. No.: US 2025/0111156 A1
(43) Pub. Date: Apr. 3, 2025

(54) TEXT PROCESSING METHOD AND COMPUTING DEVICE

(71) Applicant: Huawei Cloud Computing Technologies Co., Ltd., Guizhou (CN)

(72) Inventors: Peyvand Teymoori, North York (CA); Chung-Man Abelard Chow, Markham (CA); JinRong Luo, Markham (CA); Ming Chen, Markham (CA); Qimeng Wei, Shenzhen (CN)

(21) Appl. No.: 18/480,342

(22) Filed: Oct. 3, 2023

(51) Int. Cl. G06F 40/284; G06F 40/242; G06T 11/20

(52) U.S. Cl. CPC G06F 40/284; G06F 40/242; G06T 11/206

(57) ABSTRACT

A text processing method includes: receiving text for describing a process of a task; obtaining a first sub-sentence group from the text for describing the process of the task, the first sub-sentence group including a plurality of sub-sentences arranged in an order in which the process occurs, and each of the plurality of sub-sentences including a workflow component; determining a workflow label corresponding to each sub-sentence in the first sub-sentence group; generating the workflow of the task based on the workflow labels corresponding to the plurality of sub-sentences in the first sub-sentence group; and generating a visual representation of the generated workflow for display by the workflow generation application.

### TECHNICAL FIELD

The present disclosure relates to the technical field of natural language processing (NLP), and in particular, to a text processing method and a computing device.

### BACKGROUND

With the development of artificial intelligence (AI) technology, the use of AI models for natural language processing has become the main focus of the industry.

Presently, a widely employed AI model in the domain of natural language processing is the transformer. In a transformer, which includes encoders and decoders, the encoders' role is to process input text, transforming it into numerical vectors (termed as hidden state vectors) comprehensible by computers but not by humans. These hidden state vectors contain contextual information pertaining to the input text. This process is termed natural language understanding (NLU). Subsequently, the encoders forward these hidden state vectors to the decoders, which, leveraging these vectors, generate responses akin to human language—in other words, human-like responses. This process is termed natural language generation (NLG).

Natural language processing is progressively focused on enhancing the comprehensibility of its outputs to humans. The pursuit of methods for generating human-understandable descriptions remains a valuable area of study.

### SUMMARY

In a first aspect, a text processing method is provided. Applied to a computing device, the method includes: receiving, as input to a workflow generation application executing on the computing device, text for describing a process of a task for which a workflow is generated; obtaining a first sub-sentence group from the text for describing the process of the task, the first sub-sentence group including a plurality of sub-sentences arranged in an order in which the process occurs, each of the plurality of sub-sentences in the first sub-sentence group including a workflow component, and the workflow component being configured to indicate information of a corresponding functional unit of a plurality of functional units for performing the task; determining a workflow label corresponding to each sub-sentence in the first sub-sentence group, workflow labels corresponding to the plurality of sub-sentences in the first sub-sentence group including a first workflow label for indicating a workflow component or a second workflow label for indicating a workflow pattern; generating the workflow of the task based on the workflow labels corresponding to the plurality of sub-sentences in the first sub-sentence group; and generating a visual representation of the generated workflow for display by the workflow generation application.

In a possible implementation, obtaining the first sub-sentence group from the text for describing the process of the task includes: decomposing the text for describing the process of the task to obtain a third sub-sentence group, each of a plurality of sub-sentences included in the third sub-sentence group including at most one workflow component; filtering the plurality of sub-sentences in the third sub-sentence group to obtain a fourth sub-sentence group, each of a plurality of sub-sentences included in the fourth sub-sentence group including one workflow component; and reordering the plurality of sub-sentences in the fourth sub-sentence group to obtain the first sub-sentence group.

In a possible implementation, obtaining the first sub-sentence group from the text for describing the process of the task includes: decomposing the text for describing the process of the task to obtain a third sub-sentence group, each of a plurality of sub-sentences included in the third sub-sentence group including at most one workflow component; filtering the plurality of sub-sentences in the third sub-sentence group to obtain a fourth sub-sentence group, each of a plurality of sub-sentences included in the fourth sub-sentence group including one workflow component; reordering the plurality of sub-sentences in the fourth sub-sentence group to obtain a second sub-sentence group; and inserting at least one identifier of at least one workflow pattern into the second sub-sentence group to obtain the first sub-sentence group, the at least one workflow pattern being configured to indicate a structure of the process of the task and a relationship between the plurality of functional units.

In a possible implementation, decomposing the text for describing the process of the task to obtain the third sub-sentence group includes: performing sentence boundary detection on the text to obtain a plurality of sentences of the text; and splitting, by a first encoder-based model, each of the plurality of sentences of the text into one or more sub-sentences to obtain the third sub-sentence group.

In a possible implementation, filtering the plurality of sub-sentences in the third sub-sentence group to obtain the fourth sub-sentence group includes: determining, by a second encoder-based model, whether each sub-sentence of the plurality of sub-sentences in the third sub-sentence group includes one workflow component; and if the sub-sentence in the third sub-sentence group includes zero workflow component, removing the sub-sentence in the third sub-sentence group, so as to obtain the fourth sub-sentence group.

In a possible implementation, reordering the plurality of sub-sentences in the fourth sub-sentence group includes: reordering, by a third encoder-based model, the plurality of sub-sentences in the fourth sub-sentence group, an input of the third encoder-based model being two sub-sentences in the fourth sub-sentence group, and an output of the third encoder-based model being information for indicating whether an order of the two sub-sentences is correct.

In a possible implementation, an identifier of each workflow pattern of the at least one workflow pattern includes a workflow pattern boundary indicating sentence and/or a workflow pattern indicator; and inserting the at least one identifier of the at least one workflow pattern into the second sub-sentence group to obtain the first sub-sentence group includes: determining the at least one workflow pattern of the second sub-sentence group; for each workflow pattern of the at least one workflow pattern, obtaining the first sub-sentence group by performing, on the second sub-sentence group, at least one of the following: if no sub-sentence for indicating a boundary of the workflow pattern exists in the second sub-sentence group, inserting the workflow pattern boundary indicating sentence of the workflow pattern into the second sub-sentence group; or if no sub-sentence serving as the workflow pattern indicator exists in the second sub-sentence group, inserting the workflow pattern indicator of the workflow pattern into the second sub-sentence group.

In a possible implementation, determining the at least one workflow pattern of the second sub-sentence group includes: performing a pattern keyword detection on a plurality of sub-sentences in the second sub-sentence group; and determining the at least one workflow pattern according to at least one pattern keyword that is detected, each of the at least one pattern keyword being configured to indicate a workflow pattern of the at least one workflow pattern.

In a possible implementation, determining the workflow label corresponding to each sub-sentence in the first sub-sentence group includes: matching each sub-sentence in the first sub-sentence group to a plurality of workflow labels included in a label dictionary, so as to determine the workflow label corresponding to each sub-sentence in the first sub-sentence group from the label dictionary. Workflow labels are a simplified representation of workflow components and workflow patterns, and are used to generate workflows.

In a possible implementation, the label dictionary further includes pre-defined values corresponding to the plurality of workflow labels; and matching each sub-sentence in the first sub-sentence group to the plurality of workflow labels included in the label dictionary, so as to determine the workflow label corresponding to each sub-sentence in the first sub-sentence group from the label dictionary includes: performing semantic similarity processing to match each sub-sentence in the first sub-sentence group to the pre-defined values in the label dictionary; and determining a workflow label corresponding to a pre-defined value with a highest similarity score with respect to the sub-sentence in the pre-defined values as the workflow label corresponding to the sub-sentence.

In a second aspect, a computing device is provided. The computing device includes a memory and at least one processor connected to the memory. The memory is configured to store computer instructions that, when executed by the at least one processor, cause the computing device to implement: receiving, as input to a workflow generation application executing on the computing device, text for describing a process of a task for which a workflow is to be generated; obtaining a first sub-sentence group from the text for describing the process of the task, the first sub-sentence group including a plurality of sub-sentences arranged in an order in which the process occurs, each of the plurality of sub-sentences in the first sub-sentence group including a workflow component, and the workflow component being configured to indicate information of a corresponding functional unit of a plurality of functional units for performing the task; determining a workflow label corresponding to each sub-sentence in the first sub-sentence group, workflow labels corresponding to the plurality of sub-sentences in the first sub-sentence group including a first workflow label for indicating a workflow component or a second workflow label for indicating a workflow pattern; generating a workflow of the task based on the workflow labels corresponding to the plurality of sub-sentences in the first sub-sentence group; and generating a visual representation of the generated workflow for display by the workflow generation application.

In a possible implementation, the computer instructions, when executed by the at least one processor, cause the computing device to implement: decomposing the text for describing the process of the task to obtain a third sub-sentence group, each of a plurality of sub-sentences included in the third sub-sentence group including at most one workflow component; filtering the plurality of sub-sentences in the third sub-sentence group to obtain a fourth sub-sentence group, each of a plurality of sub-sentences included in the fourth sub-sentence group including one workflow component; and reordering the plurality of sub-sentences in the fourth sub-sentence group to obtain the first sub-sentence group, or reordering the plurality of sub-sentences in the fourth sub-sentence group to obtain a second sub-sentence group and inserting at least one identifier of at least one workflow pattern into the second sub-sentence group to obtain the first sub-sentence group, the at least one workflow pattern being configured to indicate a structure of the process of the task and a relationship between the plurality of functional unit.

In a possible implementation, the computer instructions, when executed by the at least one processor, cause the computing device to implement: performing sentence boundary detection on the text to obtain a plurality of sentences of the text; and splitting, by a first encoder-based model, each of the plurality of sentences of the text into one or more sub-sentences to obtain the third sub-sentence group.

In a possible implementation, the computer instructions, when executed by the at least one processor, cause the computing device to implement: determining, by a second encoder-based model, whether each sub-sentence of the plurality of sub-sentences in the third sub-sentence group includes one workflow component; and if the sub-sentence in the third sub-sentence group includes zero workflow component, removing the sub-sentence in the third sub-sentence group, so as to obtain the fourth sub-sentence group.

In a possible implementation, the computer instructions, when executed by the at least one processor, cause the computing device to implement: reordering, by a third encoder-based model, the plurality of sub-sentences in the fourth sub-sentence group, an input of the third encoder-based model being two sub-sentences in the fourth sub-sentence group, and an output of the third encoder-based model being information for indicating whether an order of the two sub-sentences is correct.

In a possible implementation, an identifier of each workflow pattern of the at least one workflow pattern includes a workflow pattern boundary indicating sentence and/or a workflow pattern indicator. The computer instructions, when executed by the at least one processor, cause the computing device to implement: determining the at least one workflow pattern of the second sub-sentence group; for each workflow pattern of the at least one workflow pattern, obtaining the first sub-sentence group by performing, on the second sub-sentence group, at least one of the following: if no sub-sentence for indicating a boundary of the workflow pattern exists in the second sub-sentence group, inserting the workflow pattern boundary indicating sentence of the workflow pattern into the second sub-sentence group; or if no sub-sentence serving as the workflow pattern indicator exists in the second sub-sentence group, inserting the workflow pattern indicator of the workflow pattern into the second sub-sentence group.

In a possible implementation, the computer instructions, when executed by the at least one processor, cause the computing device to implement: performing a pattern keyword detection on a plurality of sub-sentences in the second sub-sentence group; and determining the at least one workflow pattern according to at least one pattern keyword that is detected, each of the at least one pattern keyword being configured to indicate a workflow pattern of the at least one workflow pattern.

In a possible implementation, the computer instructions, when executed by the at least one processor, cause the computing device to implement: matching each sub-sentence in the first sub-sentence group to a plurality of workflow labels included in a label dictionary, so as to determine the workflow label corresponding to each sub-sentence in the first sub-sentence group from the label dictionary.

In a possible implementation, the label dictionary further includes pre-defined values corresponding to the plurality of workflow labels. The computer instructions, when executed by the at least one processor, cause the computing device to implement: performing semantic similarity processing to match each sub-sentence in the first sub-sentence group to the pre-defined values in the label dictionary; and determining a workflow label corresponding to a pre-defined value with a highest similarity score with respect to the sub-sentence in the pre-defined values as the workflow label corresponding to the sub-sentence.

In a third aspect, a non-transitory computer-readable storage medium is provided. The non-transitory computer-readable storage medium has stored computer instructions thereon. When executed by a computer, the computer instructions cause the computer to implement: receiving, as input to a workflow generation application executing on the computing device, text for describing a process of a task for which a workflow is to be generated; obtaining a first sub-sentence group from the text for describing the process of the task, the first sub-sentence group including a plurality of sub-sentences arranged in an order in which the process occurs, each of the plurality of sub-sentences in the first sub-sentence group including a workflow component, and the workflow component being configured to indicate information of a corresponding functional unit of a plurality of functional units for performing the task; determining a workflow label corresponding to each sub-sentence in the first sub-sentence group, workflow labels corresponding to the plurality of sub-sentences in the first sub-sentence group including a first workflow label for indicating a workflow component or a second workflow label for indicating a workflow pattern; generating a workflow of the task based on the workflow labels corresponding to the plurality of sub-sentences in the first sub-sentence group; and generating a visual representation of the generated workflow for display by the workflow generation application.

In a possible implementation, when executed by a computer, the computer instructions cause the computer to implement: decomposing the text for describing the process of the task to obtain a third sub-sentence group, each of a plurality of sub-sentences included in the third sub-sentence group including at most one workflow component; filtering the plurality of sub-sentences in the third sub-sentence group to obtain a fourth sub-sentence group, each of a plurality of sub-sentences included in the fourth sub-sentence group including one workflow component; and reordering the plurality of sub-sentences in the fourth sub-sentence group to obtain the first sub-sentence group, or reordering the plurality of sub-sentences in the fourth sub-sentence group to obtain a second sub-sentence group and inserting at least one identifier of at least one workflow pattern into the second sub-sentence group to obtain the first sub-sentence group, the at least one workflow pattern being configured to indicate a structure of the process of the task and a relationship between the plurality of functional units.

### BRIEF DESCRIPTION OF THE DRAWINGS

FIG. 1 is an architectural diagram of a smart integration system provided in some embodiments of the present disclosure;

FIG. 2 is a flowchart of a text processing method provided in some embodiments of the present disclosure;

FIG. 3 is a schematic diagram of a hardware structure of a mobile phone provided in some embodiments of the present disclosure;

FIG. 4 is a schematic diagram of a text processing method provided in some embodiments of the present disclosure;

FIG. 5A is a schematic diagram of another text processing method provided in some embodiments of the present disclosure;

FIG. 5B is a schematic diagram of yet another text processing method provided in some embodiments of the present disclosure;

FIG. 6 is a structural diagram of an encoder-based model provided in some embodiments of the present disclosure;

FIG. 7 is a structural diagram of another encoder-based model provided in some embodiments of the present disclosure;

FIG. 8 is a structural diagram of yet another encoder-based model provided in some embodiments of the present disclosure;

FIG. 9 is a schematic diagram of yet another text processing method provided in some embodiments of the present disclosure;

FIG. 10 is a schematic diagram of a visual representation of a workflow provided in some embodiments of the present disclosure; and

FIG. 11 is a structural diagram of a computing device provided in some embodiments of the present disclosure.

### DETAILED DESCRIPTION

Technical solutions in some embodiments of the present disclosure will be described clearly and completely with reference to the accompanying drawings below. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meaning, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

In the description of some embodiments, the term “connected” and its derivatives may be used. For example, the term “connected” may be used when describing some embodiments to indicate that two or more components are in direct physical contact or electrical contact with each other. However, the term “connected” or “communicatively connected” may also mean that two or more components are not in direct contact with each other but still cooperate or interact with each other. The embodiments disclosed herein are not necessarily limited to the content herein.

The term “and/or” merely describes an association of associated objects, which include three situations. For example, “A and/or B” refers to three situations: A alone, A and B, and B alone.

Hereinafter, the terms “first” and “second” are used for descriptive purposes only, and are not to be construed as indicating or implying the relative importance or implicitly indicating the number of indicated technical features. Thus, features defined with “first” and “second” may explicitly or implicitly include one or more of the features, and the terms “first” and “second” are not used to describe a specific order of the objects. For example, “the first sub-sentence group” and “the second sub-sentence group” are used for distinguishing different sub-sentence groups, rather than describing a specific order of the sub-sentence groups.

In the description of the embodiments of the present disclosure, the term “multiple”, “a plurality of” or “the plurality of” means two or more unless otherwise specified, and “multiple”, “a plurality of” or “the plurality of” may also be described as “at least two”.

As used herein, the term “if” is, optionally, construed as “when”, “in a case where”, “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

The use of the phrase “applicable to” or “configured to” herein means an open and inclusive language, which does not exclude devices that are applicable to or configured to perform additional tasks or steps.

In addition, the phrase “based on” used herein has an open and inclusive meaning, since a process, step, calculation or other action that is “based on” one or more of the stated conditions or values may, in practice, be based on additional conditions or values exceeding those stated.

Some embodiments of the present disclosure provide a text processing method. The text processing method is a natural language processing (NLP) method, and its main purpose is to transform a text for describing a process of a task into a concise workflow that is easy for humans to understand based on artificial intelligence (AI) technology. This method is a new breakthrough in natural language generation (NLG).

Firstly, some of the technical terms involved in the text processing method and device provided in embodiments of the present disclosure will be explained below.

### 1. Workflow

Workflow is an abstract and general description of the various operation steps of a task according to a certain rule (such as the sequence and logical relationship of the steps). In a computer, a workflow is expressed through a workflow model; for example, a workflow model can be a workflow diagram.

By using workflows, tasks can be decomposed into different sub-tasks (each sub-task includes one or more operational steps), and the tasks can be executed and monitored according to certain rules and processes, making it easier and more efficient to control and manage the process of the tasks.

### 2. Workflow Component

Workflow component is defined as information about functional units used for performing tasks. The information about functional units used for performing tasks includes workflow entity and workflow attribute. A workflow entity refers to a functional unit to execute a particular task that is necessary for a workflow to function properly. A workflow attribute refers to a parameter/configuration associated with a workflow entity.

It will be understood that the type of the workflow entity may include processor, trigger (e.g., scheduler), connector (e.g., database), etc.

For example, a sentence 1 “Connect to MySQL database to fetch employee IDs and phone numbers” includes three workflow components, that is, “MySQL”, “employee IDs”, and “employee phone numbers”. Here, “MySQL” is a workflow entity, and the type of “MySQL” is “database”; “employee IDs” and “employee phone numbers” are both workflow attributes.

For another example, a sentence 2 “Add filter and splitter processors to process the data and send the output to Oracle database” includes three workflow components, that is, “filter”, “splitter”, and “Oracle”. Here, “filter” and “splitter” are both workflow entities, and the types of “filter” and “splitter” are both “processor”; “Oracle” is also a workflow entity, but the type of “Oracle” is “database”.

### 3. Workflow Pattern

Workflow pattern is used to indicate the structure of the process of the task and the relationship between a plurality of functional units of the task (i.e., workflow entities). Optionally, the workflow pattern includes but is not limited to serial pattern, conditional pattern, parallel pattern and loop pattern.

The serial pattern means that the plurality of functional units of the task perform corresponding operations in a serial connection manner. The conditional pattern includes one or more conditional branches. The parallel pattern includes one or more parallel processor branches. The loop pattern includes one or more iterators.

It will be understood that each workflow pattern may be distinguished by a pattern keyword, which means that pattern keywords are used to distinguish workflow patterns. For example, the pattern keyword for the above conditional pattern may be “if/else”, the pattern keyword for the parallel pattern may be “parallel task”, and the pattern keyword for the loop pattern may be “while/this many times”.

### 4. Workflow Label

Workflow labels are used to indicate workflow components or workflow patterns. That is, the workflow labels may include workflow labels used for indicating workflow components and workflow labels used for indicating workflow patterns.

For example, the workflow label “MySQL” is a label indicating a workflow component, and the indicated workflow component is “MySQL” (a workflow entity of a type of “database”); the workflow label “Condition_branch” is a label indicating a workflow pattern, and the indicated workflow pattern is the conditional pattern.

In the field of natural language processing, a widely used AI model is Transformer, which is based on deep learning. There are three types of transformers, i.e., encoder, decoder, and encoder+decoder. The transformer has incorporated a self-attention mechanism, which enables the transformer to focus on key information, thereby saving resources and obtaining the most effective information quickly.

The encoder obtains the input text, encodes the words in the input text, and converts the input text into numerical vectors (that is, hidden state vectors) that can be understood by a computer (that is, can be processed by programming) and contains the context of the text. This process is termed natural language understanding (NLU). It will be noted that natural language understanding means that the result output by the encoder can be understood by a computer, but the result output by the encoder is not a result that can be understood by humans. Further, the encoder passes the output hidden state vectors to the decoder, and the decoder converts the hidden state vectors into a human-understandable result similar to human-like language description. This process is termed natural language generation (NLG).

Currently, natural language processing is more focused on enhancing the comprehensibility of its outputs to humans. Therefore, the ability of AI models to understand human descriptions has become the focus of the industry. How to generate descriptions that humans can understand remains a valuable area of study.

In addition, in related art, in order to generate descriptions that humans can understand, the decoder in the Transformer is very large and needs to train billions of parameters. This will cause model training take a lot of time and use a lot of computing resources, leading to a large system overhead in natural language processing.

Based on this, embodiments of the present disclosure provide a text processing method that can convert text for describing a process of a task into a workflow. Compared with the technical solution in the related art, which uses an encoder and decoder to obtain a human-understandable result similar to human-like language description, the technical solution of the present disclosure can obtain a workflow that is also understandable by humans; and compared with the human-like language description, the workflow is a more concise description.

The text processing method provided in the embodiments of the present disclosure is used to convert text for describing a process of a task into a workflow. This method enables users with only basic task-level skills to construct workflows using text descriptions, eliminating the need for advanced technical proficiency. Consequently, it reduces the skill level required for users to create workflows. Furthermore, this method can effectively solve the problem that technical documentation is not synchronized with the actual production workflow. In essence, employing the text processing method provided in the embodiments of the present ensures synchronization between technical documentation and the workflow.

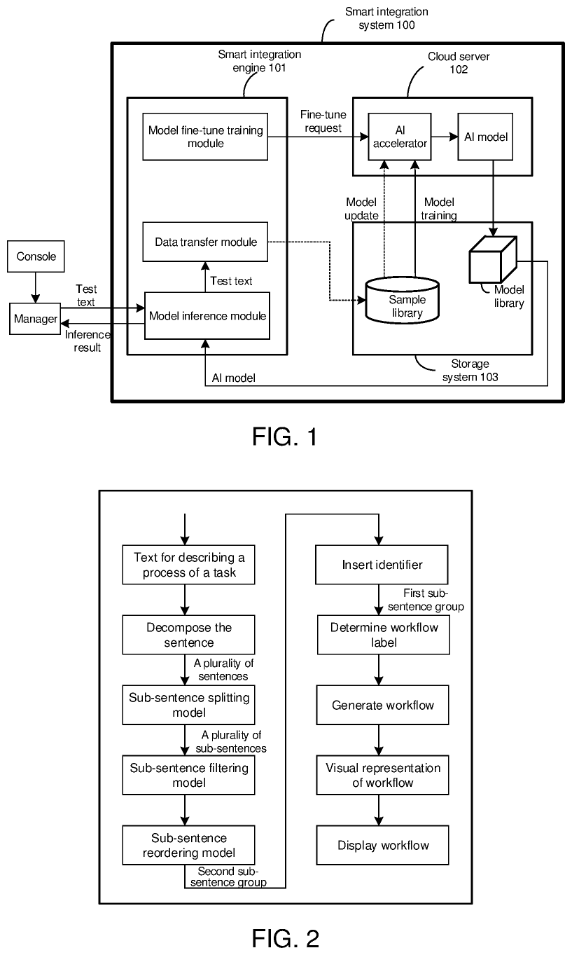

For example, the text processing method provided in the embodiments of the present disclosure may be applied in the smart integration system shown in FIG. 1. Referring to FIG. 1, the smart integration system 100 provided in the embodiments of the present disclosure includes a smart integration engine 101, a cloud server 102 and a storage system 103. A communication connection is established between any two of the smart integration engine 101, the cloud server 102 and the storage system 103.

The smart integration engine 101 is used to control the training process of the AI model (for text processing) and execute the process of text processing based on the AI model (i.e., the model inference process). As shown in FIG. 1, the smart integration engine 101 includes a model fine-tune training module, a model inference module and a data transfer module. The model fine-tune training module is used to send a fine-tune request for instructing the training of the AI model to the cloud server 102, so as to instruct the cloud server 102 to start training the AI model. The model inference module is used to process a new text (called test text) based on the trained AI model to obtain a processing result. In the embodiments of the present disclosure, the processing result may be flow generation instructions/inference ID used to generate a workflow. The data transfer module is used to transmit the test text in the model inference process and the obtained test result of the test text to the sample library as new samples and store them. Subsequently, the new training samples may be used to update the AI model, for example, to fine-tune the AI model.

For example, the smart integration engine 101 may be a computing device, such as a server and a desktop computer, and the smart integration engine 101 may also be a module or component having a processing function in the computing device. For example, the smart integration engine 101 is a processor (such as a central processing unit (CPU)). In the embodiments of the present disclosure, the smart integration engine 101 is mainly responsible for the logical calculation and logical control functions of the load. For complex and large-scale computing tasks, the smart integration engine 101 will send the computing tasks to the cloud server 102, and the cloud server 102 will execute the computing tasks.

The cloud server 102 is used to receive the computing tasks sent by the smart integration engine 101 and execute the computing tasks. For example, the cloud server 102 receives a fine-tune request for training an AI model sent by the smart integration engine 101, and performs the training process of the AI model. For example, the AI accelerator in the cloud server 102 performs the training process of the AI model.

The AI accelerator can also be called an AI chip, an AI wafer, a computing card, or a heterogeneous acceleration unit, etc. It is a module specially designed to handle a large number of computing tasks in the field of artificial intelligence. AI accelerators are also a type of processor.

For example, AI accelerators may include graphics processing units (GPUs), field programmable gate arrays (FPGAs), application-specific integrated circuits (ASICs), etc.

GPU may also be called visual processor and display chip. It is a microprocessor that specializes in image and graphics-related computing work on personal computers, workstations, game consoles, and some mobile devices (such as tablets, smartphones, etc.). GPUs contain thousands of cores and can process thousands of threads simultaneously, allowing massive calculations to be run in parallel.

FPGA is a programmable logic processor, and users can perform re-programming according to their own needs. FPGA is good at handling short and dense data access. FPGA allows users to program circuits through tiny logic blocks and can handle any type of digital function.

ASIC is a special-specification integrated circuit designed for a specific purpose. It is designed and manufactured according to specific user requirements and the needs of specific electronic systems. For example, tensor processing unit (TPU), neural network processing unit (NPU), etc. are all ASICs. TPU and NPU are chips designed for machine learning, ideally suited for processing massive data with formidable computing prowess.

The storage system 103 is used to store data, and the storage system 103 includes a sample library and a model library. The sample library is stored with a training data set for training the AI model; the training data set includes a large number of training samples, and each training sample includes raw data (for example, a sentence and other information of the sentence, such as timestamp, inference ID, etc.) and description information. The model library is used to store the trained AI model. The model inference module can obtain the AI model from the model library to execute the text processing process. The cloud server 102 can also obtain the AI model from the model library and update the AI model.

With reference to FIG. 1, the text processing process based on AI model may include three phases, namely a model training phase, a model inference phase and a model update phase.

In the model training phase, the smart integration engine 101 sends a fine-tune request to the cloud server 102 to trigger the AI accelerator in the cloud server 102 to start AI model training. For example, the fine-tune request may include a preset AI model (which may be called a basic AI model or an initialization AI model). The AI accelerator obtains a training sample set from the sample library of the storage system 103, and trains the preset AI model based on the training sample set, that is, update parameters of the preset AI model.

In the model inference phase, when there is a text processing requirement, a console of the text processing platform sends a text processing request to the smart integration engine 101 through a manager. The text processing request carries the text to be processed (i.e., the test text), and then the model inference module of the smart integration engine 101 obtains the trained AI model from the model library, processes the test text based on the AI model, obtains the prediction result of the test text, and then generates a workflow based on the prediction result.

Optionally, the test text and the prediction result of the test text obtained through model inference may be stored as a new training sample in the sample library of the storage system 103.

In the model update phase, which is a process of continuing to train the trained AI model based on new samples, the AI accelerator of the cloud server 102 reads the newly added training samples in the sample library from the sample library, and continues to train the AI model based on the new training samples. This is a process of fine-tuning the AI model.

It will be noted that the smart integration system 100 shown in FIG. 1 is an example of a system architecture in which the text processing method provided in the embodiment of the present disclosure can be applied. In this system 100, the general processing function, the computing function and the storage function are implemented by different devices, that is, the general processing function, the computing function, and the storage function are configured on different devices. For example, the general processing function is implemented by the smart integration engine 101, the computing function is implemented by the AI accelerator 102, and the storage function is implemented by the storage system 103. Of course, any two or three of the general processing function, computing function, and storage function may also be configured on the same device, which is not limited in the embodiments of the present disclosure. It will be understood that since the training of an AI model usually takes a long time, in some embodiments, the training process of the AI model may be an offline processing process, and the inference process of the AI model may be an online processing process.

In some examples, the text processing method may also be applied to other systems including general-purpose processors, AI accelerators, and storage devices, which are not specifically limited in the embodiments of the present disclosure.

In some embodiments of the present disclosure, the AI model for text processing includes at least a sub-sentence splitting model, a sub-sentence filtering model, and a sub-sentence reordering model. The sub-sentence splitting model is used to split a plurality of sentences of the input text into a plurality of sub-sentences, and the sub-sentence filtering model is used to filter the plurality of sub-sentences of the input text to remove sub-sentences with no workflow component. The sentence reordering model is used to reorder the plurality of sub-sentences of the input text according to the order of execution.

With reference to FIG. 1, the sub-sentence splitting model, sub-sentence filtering model and sub-sentence reordering model may be trained offline according to the model training process described in the above embodiments. After the model training is completed, the text may be processed based on these models to generate a workflow.

Referring to the flowchart shown in FIG. 2, in some embodiments of the present disclosure, after the text processing device for executing the text processing method obtains the text for describing the process of the task, it first decomposes the text into a plurality of sentences; then, based on the sub-sentence splitting model, each sentence in the plurality of sentences is split into sub-sentences to obtain a plurality of sub-sentences; then, based on the sub-sentence reordering model and the sub-sentence filtering model, the plurality of sub-sentences are reordered and filtered to obtain a first sub-sentence group; further, an identifier of a workflow pattern is inserted into the first sub-sentence group to obtain a second sub-sentence group; then, a workflow label corresponding to each sub-sentence in the second sub-sentence group is determined; then, according to the workflow labels corresponding to the plurality of sub-sentences in the second sub-sentence group, a workflow of the task is generated, and a visual representation of the generated workflow is generated to display the workflow.

In some embodiments of the present disclosure, the sub-sentence splitting model, sub-sentence filtering model and sub-sentence reordering model are all encoder-based models. For ease of description, in the following embodiments, the sub-sentence splitting model is referred to as the first encoder-based model, the sub-sentence filtering model is referred to as the second encoder-based model, and the sub-sentence reordering model is referred to as the third encoder-based model.

In some embodiments of the present disclosure, the text processing device for executing the text processing method described in FIG. 2 may be a workflow generation application in a computing device. For example, the computing device may be a server, a desktop computer, a mobile phone, a tablet or a personal computer (ultra-mobile personal computer, UMPC). Alternatively, the computing device may also be other desktop devices, laptop devices, handheld devices, wearable devices, smart home devices, vehicle-mounted devices and other electronic devices, such as netbooks, smart watches, smart cameras, personal digital assistants (PDA), portable multimedia players (PMP), dedicated media players or AR (augmented reality)/VR (virtual reality) devices. The embodiments of the present disclosure do not limit the specific type and structure of the computing device.

In an example where the computing device is a mobile phone, the workflow generation application is an application in the mobile phone. The hardware structure of the computing device that can be used to execute the text processing provided in the embodiments of the present disclosure is introduced below by taking an example where the computing device is a mobile phone.

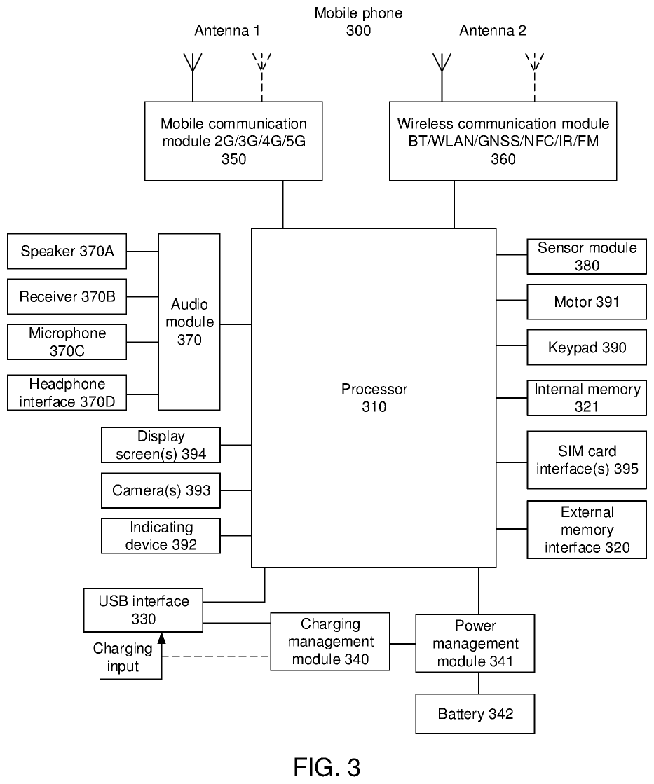

FIG. 3 is a schematic diagram of a hardware structure of a mobile phone 300 provided in some embodiments of the present disclosure. As shown in FIG. 3, the mobile phone 300 includes a processor 310, an external memory interface 320, an internal memory 321, a universal serial bus (USB) interface 330, a charging management module 340, a power management module 341, a battery 342, an antenna 1, an antenna 2, a mobile communication module 350, a wireless communication module 360, an audio module 370, a speaker 370A, a receiver 370B, a microphone 370C, a headphone interface 370D, a sensor module 380, a keypad 390, a motor 391, an indicator 392, camera(s) 393, display screen(s) 394, and subscriber identification module (SIM) card interface(s) 395.

It will be understood that the structure illustrated in the embodiments of the present disclosure does not constitute a specific limitation on the mobile phone 300. In some other embodiments of the present disclosure, the mobile phone 300 may include more or fewer components than those shown; or some components may be combined, or some components may be split, or different components may be provided. The components illustrated may be implemented in hardware, software, or a combination of software and hardware.

The processor 310 may include one or more processing units, such as a central processing unit (CPU), an application processor (AP), a modem processor, an image signal processor (ISP), a controller, a video codec, a digital signal processor (DSP), a baseband processor, a graphics processing unit (GPU), a neural network processing unit (NPU), or a tensor processing unit (TPU). Different processors may be independent devices, or may be integrated in one or more devices.

The processor 310 may include a controller, which is the nerve center and command center of the mobile phone 300. The controller can generate an operation control signal according to the instruction operation code and timing signal, so as to complete the control of fetching and executing the instruction.

The processor 310 may also be provided therein with a memory for storing instructions and data. In some embodiments, the memory in the processor 310 is a cache memory. The memory may hold instructions or data that the processor 310 has just used or recycled. If the processor 310 needs to use the instructions or data again, it may be called directly from the memory. In this way, repeated access is avoided and the waiting time of the processor 310 is reduced, thus improving the efficiency of the system.

The external memory interface 320 may be used to connect an external memory card, such as a Micro SD card, to expand the storage capacity of the mobile phone 300. The external memory card communicates with the processor 310 through the external memory interface 320 to implement the data storage function, such as saving music and video files in the external memory card.

The internal memory 321 is used to store computer executable program codes, which include instructions. The processor 310 executes various functional applications and data processing of the mobile phone 300 by executing instructions stored in the internal memory 321. The internal memory 321 may include a program storage partition and a data storage partition. The program storage partition may store an operating system, application programs required for at least one function (such as sound playback function, image playback function), etc. The data storage partition may store data created during the use of mobile phone 300 (such as audio data, phone book). In addition, the internal memory 321 may include a high-speed random access memory, and may further include a non-volatile memory, for example, at least one magnetic disk storage device, a flash memory device, or a universal flash storage.

The charging management module 340 is used to receive charging input from a charger. The charger may be connected to the mobile phone 300 through the USB interface 330. When the charging management module 340 charges the battery 342, it may also supply power to the electronic device through the power management module 341 at the same time.

The power management module 341 is used to connect the battery 342, the charging management module 340 and the processor 310. The power management module 341 receives input from the battery 342 and/or the charging management module 340, and supplies power to the processor 310, the internal memory 321, an external memory, the display screen(s) 394, the camera(s) 393, the wireless communication module 360, etc.

The wireless communication function of the mobile phone 300 may be realized by the antenna 1, the antenna 2, the mobile communication module 350, the wireless communication module 360, a modem processor and a baseband processor. The antenna 1 and the antenna 2 are used to transmit and receive electromagnetic wave signals.

The mobile communication module 350 may provide wireless communication solutions including 2G/3G/4G/5G applied on the mobile phone 300.

The wireless communication module 360 may provide wireless communication solutions including wireless local area networks (WLANs) applied on the mobile phone 300, such as Wi-Fi, Bluetooth (BT), global navigation satellite system (GNSS), frequency modulation (FM), near field communication (NFC) and infrared (IR).

In some embodiments, the antenna 1 of the mobile phone 300 is coupled to the mobile communication module 350, and the antenna 2 is coupled to the wireless communication module 360, so that the mobile phone 300 may communicate with the network and other devices through wireless communication technology.

The mobile phone 300 realizes the display function through the GPU, the display screen(s) 394, and the application processor. The GPU is an image processing microprocessor and is connected to the display screen(s) 394 and the application processor. The GPU is used to perform mathematical and geometric calculations for graphics rendering, model training, etc. The processor 310 may include one or more GPUs that execute program instructions to generate or alter display information.

The display screen 394 is used to display images, videos, etc. The display device includes a display panel. In some embodiments, the mobile phone 300 may include 1 or N display screens 394, where N is a positive integer greater than 1.

The mobile phone 300 may realize the shooting function through the ISP, the camera(s) 393, the video codec, GPU, the display screen(s) 394 and the application processor. The mobile phone 300 may realize the audio functions, such as music playback and sound recording, through the audio module 370, the speaker 370A, the receiver 370B, the microphone 370C, the headphone interface 370D, and the application processor.

The audio module 370 is used to convert digital audio information into analog audio signal output, and is also used to convert analog audio input into digital audio signal. The audio module 370 may also be used to encode and decode audio signals. In some embodiments, the audio module 370 may be provided in the processor 310, or some functional modules of the audio module 370 may be provided in the processor 310.

It will be understood that in the embodiment of the present disclosure, the mobile phone 300 may perform some or all of the steps in the embodiments of the present disclosure. These steps or operations are only examples, and the mobile phone 300 may also perform other operations or variations of various operations. Furthermore, the various steps may be performed in a different order than that presented in the embodiments of the present disclosure, and it is possible that not all operations in the embodiments of the present disclosure are performed. The embodiments of the present disclosure may be implemented independently or in any combination, which is not limited by the embodiments of the present disclosure.

The text processing method provided in the embodiments of the present disclosure may be applied to a computing device with a hardware structure as shown in FIG. 3 or a computing device with a similar structure. Alternatively, it may also be applied to computing devices with other structures, which is not limited by the embodiments of the present disclosure.

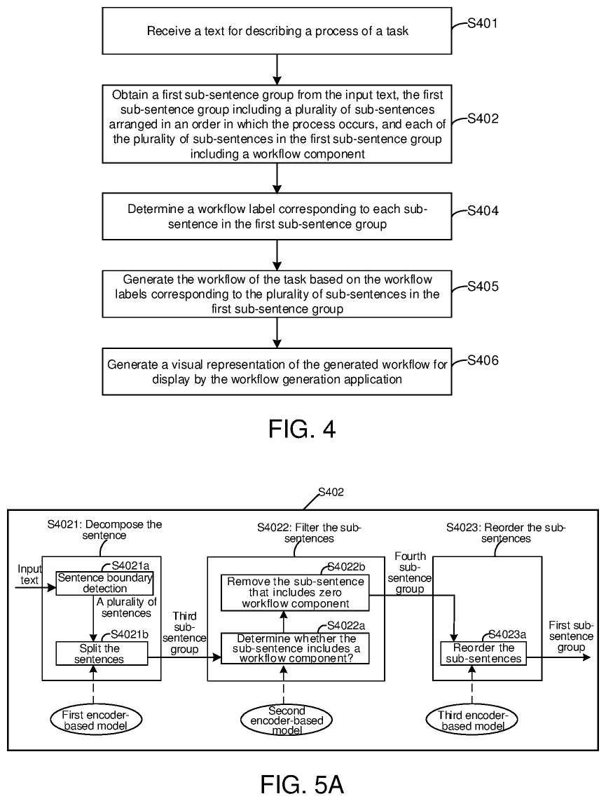

Based on the above description, the text processing method provided in the embodiments of the present disclosure may be executed by a computing device. For example, it may be executed by a workflow generation application running in a computing device. As shown in FIG. 4, the text processing method provided in the embodiments of the present disclosure includes steps S401-S404.

In S401, a text for describing a process of a task is received.

In the embodiments of the present disclosure, after the workflow generation application in the computing device receives the text for describing the process of the task, the text is used as input to the workflow generation application, and then the text is processed in the workflow generation application. For the convenience of description, in the following embodiments, the text for describing the process of the task is uniformly referred to as “input text”.

In some examples, the text for describing the process of the task may be text stored locally on the computing device, or may be text received by the computing device from other devices, which is not limited by the embodiments of the present disclosure.

In S402, a first sub-sentence group is obtained from the input text. The first sub-sentence group includes a plurality of sub-sentences arranged in an order in which the process occurs, and each of the plurality of sub-sentences in the first sub-sentence group includes a workflow component.

The workflow component is used to indicate information of a corresponding functional unit among the plurality of functional units used to execute the task. The workflow component may include workflow entity or workflow attribute. For more detailed description about the workflow component, reference may be made to the description of the definition of workflow component in the above embodiments.

In some embodiments of the present disclosure, the first sub-sentence group is a group containing the plurality of sub-sentences obtained after the input text is processed, and each sub-sentence in the obtained first sub-sentence group includes one workflow component. In this way, the structure of each sub-sentence is made the simplest, which facilitates one-to-one mapping of sub-sentences and workflow labels based on workflow components in the next phase. Moreover, the plurality of sub-sentences in the first sub-sentence group are arranged in the order in which the process occurs, which helps to generate a correct workflow later.

For example, the following text (text 1) for describing the process of the task is used as the input text.

Text 1: “Connect to MySQL database to query data after the scheduler is triggered. Then, add a Condition processor and if condition A, add a parallel processor. In parallel task 1, add filter and splitter processors to process the data and send the output to Oracle database. In parallel task 2, send the data to DB2 when sorting was finished. After that merges the parallel processing branches. If condition B, convert the data to the required format and send the output to PostgreSQL and then merge the results of the router branches. Finally, send notification through SMN service.”

A sub-sentence group (which may be used as the second sub-sentence group mentioned below) obtained after the above input text is processed in step S402 is:
“After the scheduler is triggered. Connect to MySQL database. Add a Condition processor. If condition A, add a parallel processor. In parallel task 1, add splitter processor. Add a filter processor. Send the output to Oracle database. In parallel task 2, when sorting was finished. Send the data to DB2. After that merges the parallel processing branches. If condition B, convert the data to the required format. Send the output to PostgreSQL. Merge the results of the router branches. Finally, send notification through SMN service.”

In the above example, each sub-sentence in the above sub-sentence group includes only one workflow component, and the sub-sentences are arranged in the order in which the process occurs.

Table 1 below shows the workflow component in each sub-sentence in the above sub-sentence group and the type of the workflow component.

TABLE 1

| | | Workflow | |
|---|---|---|---|
| | Workflow | entity/workflow | |
| Sub-sentences | component | attribute | Type |
| After the scheduler | Scheduler | Workflow entity | Trigger |
| is triggered. | | | |
| Connect to MySQL | MySQL | Workflow entity | Connector |
| database. | | | |
| Add a Condition | Router | Workflow entity | Connector |
| processor. | | | |
| If condition A, | Parallel | Workflow entity | Processor |
| add a parallel | processor | | |
| processor. | | | |
| In parallel task 1, | Splitter | Workflow entity | Processor |
| add splitter | | | |
| processor. | | | |
| Add a filter processor. | Filter | Workflow entity | Processor |
| Send the output to | Oracle | Workflow entity | Connector |
| Oracle database. | | | |
| In parallel task 2, | Sort | Workflow entity | processor |
| when reordering was | | | |
| finished. | | | |
| Send the data to DB2. | DB2 | Workflow entity | Connector |
| After that merges | Parallel | Workflow entity | Processor |
| the parallel | processor | | |
| processing branches. | | | |
| If condition B, | Data conversion | Workflow entity | Processor |
| convert the data | | | |
| to the required format. | | | |
| Send the output | PostgreSQL | Workflow entity | Connector |
| to PostgreSQL. | | | |
| Merge the results of | Router | Workflow entity | Connector |
| the router branches. | | | |
| Finally, send | SMN service | Workflow entity | Connector |
| notification through | | | |
| SMN service. | | | |

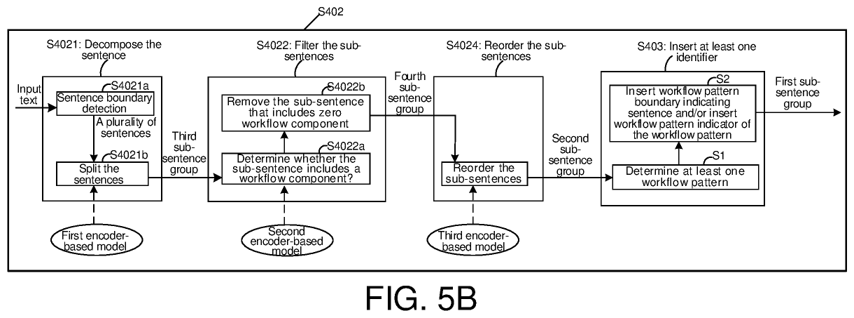

In some embodiments, referring to FIG. 5A, the above step S402 includes steps S4021 to S4023.

In S4021, the input text is decomposed to obtain a third sub-sentence group.

Each of a plurality of sub-sentences included in the third sub-sentence group includes at most one workflow component.

In some embodiments, with continued reference to FIGS. 5A and 5B, S4021 may be implemented through S4021a and S4021b.

In S4021a, sentence boundary detection is performed on the input text to obtain a plurality of sentences of the input text.

In some embodiments of the present disclosure, sentence boundary detection (SBD) technology may be used. Optionally, the input text may be segmented into a plurality of sentences using rule-based, unsupervised learning or supervised learning methods.

In S4021b, each of the plurality of sentences of the text is split into one or more sub-sentences by a first encoder-based model to obtain the third sub-sentence group.

It will be understood that the first encoder-based model (i.e., the sub-sentence splitting model) is a Transformer model, and the first encoder-based model is a token classification model. The input of the first encoder-based model is a sentence. Each word or sub-word in the sentence may be regarded as a token. The output of the first encoder-based model is the BIOE (begin inside outside end) tag of each token in the input sentence (the token may be a word or a sub-word). It can be seen that the first encoder-based model is a multi-classification model. In the embodiments of the present disclosure, a sentence may be split into one or more sub-sentences according to the output BIOE tag.

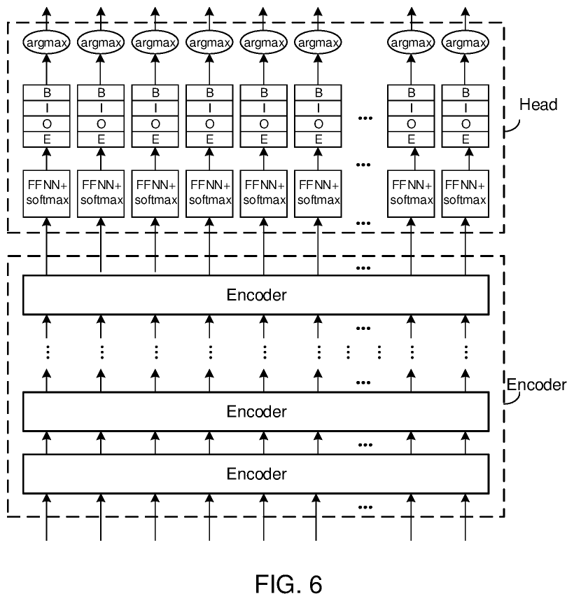

Referring to FIG. 6, the first encoder-based model includes a plurality of encoders connected in sequence and a plurality of heads. For any one of the plurality of encoders, the encoder includes a plurality of input terminals and a plurality of output terminals, and each output terminal of the encoder corresponds to a head. The head includes feed forward neural network (FFNN), softmax function and argmax function. Each input terminal of the encoder is input with a token of a sentence to be split, and each output terminal of the encoder outputs a hidden state vector corresponding to a token. The hidden state vector corresponding to the token is input to the FFNN, and after the normalization process of the softmax function, the probability values of the BIOE tags of the token are obtained. That is, the probability values of the token belonging to the four tags of B, I, O, and E respectively are obtained. Then, after the processing of the argmax function, the tag corresponding to the largest probability value is determined as the BIOE tag corresponding to the token. Next, according to the BIOE tag of each token in the input sentence, the input sentence is split into one or more sub-sentences by using a B tag to mark the start of a sub-sentence and an E tag to mark the end of a sub-sentence.

For example, the encoder in the first encoder-based model may be any one of BERT, ALBERT, DistilBERT, ELECTAR, ROBERTa, etc. The embodiments of the present disclosure do not limit the first encoder-based model.

For example, when the input sentence is “The tickets were sold out so we watched a movie on TV”, each word in the input sentence is used as a token. After the processing of the first encoder-based model shown in FIG. 6, the BIOE tag corresponding to each token in the input sentence is shown in Table 2 below.

TABLE 2

| Token | The | tickets | were | sold | out | so | we | watched | a | movie | on | TV |
|---|---|---|---|---|---|---|---|---|---|---|---|---|
| Tag | B | I | I | I | E | O | B | I | I | I | I | E |

In combination with the output results of the first encoder-based model shown in Table 2, the output results are aggregated, and two sub-sentences are obtained: “The tickets were sold out”, and “we watched a movie on TV”.

In some examples, the first encoder-based model is obtained by training based on an annotated training data set, and the training data set includes a plurality of raw sentences and an annotated correct BIOE tag of each token in the raw sentences.

In S4022, the plurality of sub-sentences in the third sub-sentence group are filtered to obtain a fourth sub-sentence group. Each of a plurality of sub-sentences included in the fourth sub-sentence group includes one workflow component

In some embodiments of the present disclosure, sub-sentences that do not include workflow components are invalid information in the process of generating workflows, so the sub-sentences that do not include workflow components (i.e., the sub-sentences that include zero workflow component) are removed from the third sub-sentence group. As a result, the remaining sub-sentences each include one workflow component, which helps to generate a more streamlined and accurate workflow.

In some embodiments, with continued reference to FIGS. 5A and 5B, the above S4022 may be implemented through S4022a and S4022b.

In S4022a, it is determined by a second encoder-based model whether each sub-sentence in the third sub-sentence group includes one workflow component.

In S4022b, if it is determined that the sub-sentence in the third sub-sentence group includes zero workflow component, the sub-sentence that includes zero workflow component in the third sub-sentence group is removed, and the sub-sentence that includes a workflow component in the third sub-sentence group is retained, so as to obtain the fourth sub-sentence group.

It will be understood that the second encoder-based model (i.e., the sub-sentence filtering model) is a Transformer model, and the second encoder-based model is a binary classification model. The input of the second encoder-based model is a sub-sentence. Each word or sub-word in the sub-sentence may be regarded as a token. The output of the second encoder-based model is indication information for indicating whether the input sub-sentence includes a workflow component. It can be seen that the second encoder-based model is a binary classification model.

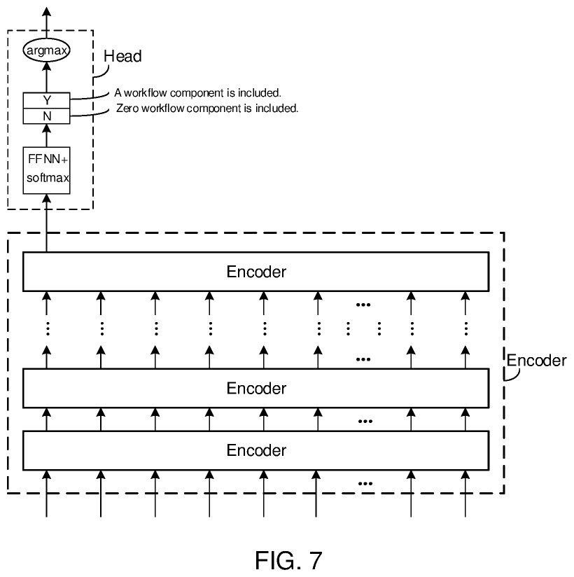

Referring to FIG. 7, the second encoder-based model includes a plurality of sequentially connected encoders and one head. Among the plurality of encoders, all other encoders except the last encoder include a plurality of input terminals and a plurality of output terminals. The last encoder includes one output terminal, and the output terminal of the last encoder is connected to the head. The head includes feed forward neural network (FFNN), softmax function and argmax function. Each input terminal of the first encoder is input with each token in a sub-sentence, and each output terminal of the encoder outputs a hidden state vector corresponding to a token. The output of the last encoder is the hidden state vector corresponding to the input sub-sentence. Then, the hidden state vectors are input into FENN, and after the normalization process of the softmax function, the probability value of the indication information (Y or N) for indicating whether the input sub-sentence includes a workflow component is obtained. The indication information for indicating that the sub-sentence includes a workflow component is Y, and the indication information for indicating that the sub-sentence includes zero workflow component is N. Then, after the processing of the argmax function, the indication information corresponding to the largest probability value is determined as the indication information corresponding to the sub-sentence. Next, according to the indication information, it is determined whether the input sub-sentence includes a workflow component or zero workflow component.

For example, when the input sub-sentence is “Connect to MySQL database”, the indicator “CLS” used to indicate the start of the sentence and the indicator “Sep” used for separating sentences are respectively added at the start and end of the sub-sentence. Each word in the input sentence is input as a token to the second encoder-based model, and the indication information output by the second encoder-based model is “Y”; then, it can be determined that the sub-sentence includes a workflow component, and the sub-sentence is retained.

Optionally, the second encoder-based model is obtained by training based on an annotated training data set, and the training data set includes a plurality of sentences and annotated tags indicating whether the sub-sentences include workflow components.

In S4023, the plurality of sub-sentences in the fourth sub-sentence group are reordered to obtain the first sub-sentence group.

In some embodiments of the present disclosure, by reordering the plurality of sub-sentences in the fourth sub-sentence group, the plurality of sub-sentences in the fourth sub-sentence group may be arranged in the order in which the process of the task occurs, which makes it possible to generate an accurate workflow based on the reordered sub-sentences in the subsequent steps.

In some embodiments, with continued reference to FIG. 5A, S4023 may be implemented through S4023a.

In S4023a, the plurality of sub-sentences in the fourth sub-sentence group are reordered by a third encoder-based model to obtain the first sub-sentence group.

The input of the third encoder-based model is two sub-sentences in the fourth sub-sentence group, and the output of the third encoder-based model is information for indicating whether the order of the two sub-sentences is correct.

It will be understood that the third encoder-based model (i.e., the sub-sentence reordering model) is a Transformer model, and the third encoder-based model is a binary classification model. The input of the third encoder-based model is two sub-sentences. Each word or sub-word in the sub-sentence may be regarded as a token. The output of the third encoder-based model is indication information for indicating whether the order of the input two sub-sentences is correct. It can be seen that the third encoder-based model is also a binary classification model.

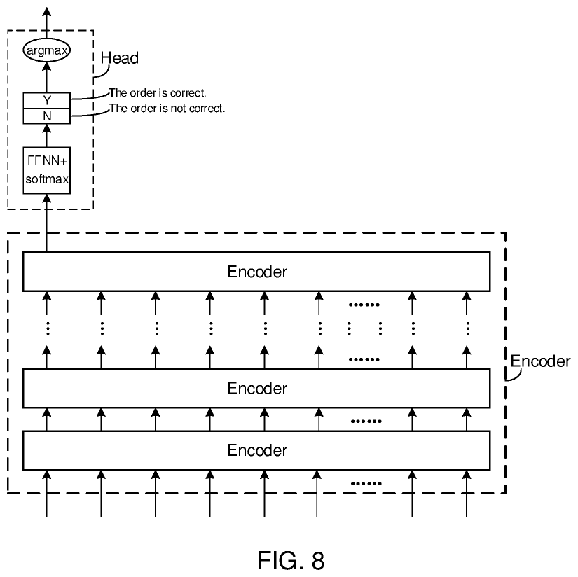

Referring to FIG. 8, the third encoder-based model includes a plurality of sequentially connected encoders and one head. Among the plurality of encoders, all other encoders except the last encoder include a plurality of input terminals and a plurality of output terminals. The last encoder includes one output terminal, and the output terminal of the last encoder is connected to the one head. The head includes feed forward neural network (FFNN), softmax function and argmax function. Each input terminal of the first encoder is input with each token in two sub-sentences, and each output terminal of the encoder outputs a hidden state vector corresponding to a token. The output of the last encoder is the hidden state vector of the category corresponding to the input two sub-sentences. Then, the hidden state vectors are input into FFNN, and after the normalization process of the softmax function, the probability value of the indication information (Y or N) for indicating whether the order of the two sub-sentences is correct is obtained. The indication information for indicating that the order of the two sub-sentences is correct is Y, and the indication information for indicating that the order of the two sub-sentences is not correct is N. Then, after the processing of the argmax function, the indication information corresponding to the largest probability value is determined as the indication information corresponding to the sub-sentence. Next, according to the instruction information, it is determined whether the order of the input two sub-sentences is correct, that is, whether the two sub-sentences need to be reordered.

For example, if the input two sub-sentences are “Connect to MySQL database” and “After the scheduler is triggered”, the original order of these two sub-sentences is that “Connect to MySQL database” comes before “After the scheduler is triggered”. After adding “CLS” and “Sep” to the sub-sentences, each word in the sub-sentence is input as a token into the third encoder-based model, and the indication information output by the third encoder-based model is “N”. Then, it may be determined that the order of these two sub-sentences is not correct, and they need to be reordered by putting “After the scheduler is triggered” before “Connect to MySQL database”.

It will be noted that the fourth sub-sentence group includes a plurality of sub-sentences. In a case where the fourth sub-sentence group includes at least three sub-sentences, the plurality of sub-sentences in the fourth sub-sentence group may be reordered based on the third encoder-based model by a bubble sorting method.

Optionally, the third encoder-based model is obtained by training based on an annotated training data set, and the training data set includes a plurality of pairs of sub-sentences and annotated tags indicating whether the order of each pair of sub-sentences is correct.

In combination with the above description of S4021 and S4023, the first encoder-based model, the second encoder-based model and the third encoder-based model may all be pre-trained models. Most parameters in the pre-trained models are already well-optimized. In the embodiments of the present disclosure, the first encoder-based model, the second encoder-based model, and the third encoder-based model may be fine-tuned based on small and medium-sized data sets, so that each model adapts to a current data set.

In some embodiments of the present disclosure, the model used for sub-sentence splitting, the model used for sub-sentence filtering, and the model used for sub-sentence reordering are all Transformer models that only include encoders and do not include a decoder. Compared with the method that uses a model including encoders and decoders to convert input text into a description that can be understood by humans, the model used in the method provided in the embodiments of the present disclosure is much simpler. As such, in the process of training and applying the models, the amount of calculation, the time overhead and the resource overhead may all be reduced.

It will be noted that the embodiments of the present disclosure do not limit the performing order of the above S4022 and S4023. For example, S4022 may be performed before S4023, or S4022 may be performed after S4023.

In some examples, referring to FIG. 5B, the above S402 includes the above S4021 and S4022, and further includes S4024 and S403.

In S4024, the plurality of sub-sentences in the fourth sub-sentence group are reordered to obtain a second sub-sentence group.

As for the description of S4024, reference may be made to the description of the above S4023, and details will not be repeated here. For example, the plurality of sub-sentences in the fourth sub-sentence group are reordered by the third encoder-based model to obtain the second sub-sentence group.

In S403, at least one identifier of at least one workflow pattern is inserted into the second sub-sentence group to obtain the first sub-sentence group.

The input text in the embodiments of the present disclosure is text used for describing the process of the task. Generally, the process has a certain structure, and there is a certain relationship between the plurality of functional units (that is, workflow entities) that execute the task. In the embodiments of the present disclosure, information indicating the structure of the process of the task and the relationship between the plurality of functional units (i.e., workflow entities) of the task are defined as workflow pattern. The workflow pattern includes but is not limited to serial pattern, conditional pattern, parallel pattern or loop pattern. As for more detailed description of the workflow pattern, reference may be made to the introduction to the definition of workflow pattern in the above embodiments, and details will not be repeated here.

It will be understood that, for at least one workflow pattern of the second sub-sentence group, each workflow pattern corresponds to an identifier, and the identifier includes a workflow pattern boundary indicating sentence and/or a workflow pattern indicator. The workflow pattern boundary indicating sentence is a sentence (or sub-sentence) associated with the start of the workflow pattern or the end of the workflow pattern. That is, the workflow pattern boundary indicating sentence may be a sentence (or sub-sentence) that can indicate the start or end of the workflow pattern. The workflow pattern indicator is used to indicate the type of workflow pattern and a boundary of the workflow pattern.

For example, for a conditional pattern, the workflow pattern boundary indicating sentence indicating the start of the conditional pattern may be “Add a Condition processor”, and the workflow pattern boundary indicating sentence indicating the end of the conditional pattern may be “Merge the results of the router branches”. The workflow pattern indicator for the conditional pattern may be “Create a conditional branch”.

In a possible implementation, the above S403 is implemented through the following S1 and S2.

In S1, the at least one workflow pattern of the second sub-sentence group is determined.

The description that the input text includes at least one workflow pattern may also be understood as that the process described by the plurality of sub-sentences in the second sub-sentence group includes at least one workflow pattern. The at least one workflow pattern may be referred to as at least one workflow pattern of the input text or at least one workflow pattern of the second sub-sentence group. For example, the workflow patterns of text 1 illustrated above include a conditional pattern and a parallel pattern.

In the embodiments of the present disclosure, the at least one workflow pattern of the input text may be determined based on the plurality of sub-sentences in the second sub-sentence group. In some embodiments, the at least one workflow pattern may be determined by pattern keyword extraction, that is, at least one pattern keyword is extracted from the plurality of sub-sentences. One pattern keyword is used to indicate one workflow pattern. For example, the pattern keyword for conditional pattern may be “if”, the pattern keyword for parallel pattern may be “parallel task”, and the pattern keyword for loop pattern may be “while”.

Optionally, a machine learning method may be used to determine the at least one workflow pattern of the input text. For example, an AI model for determining the workflow pattern may be trained. The sub-sentences in the second sub-sentence group may be used as input to the AI model. The AI model may analyze the input sub-sentences, extract the pattern keyword(s), and output at least one workflow pattern of the second sub-sentence group (that is, at least one workflow pattern of the input text).

For example, for the second sub-sentence group in the above example, the extracted pattern keywords include “if” and “parallel”. For example, “if” is extracted from the sub-sentence “If condition A, add a parallel processor”, and “parallel task” is extracted from the sub-sentence “In parallel task 1, add splitter processor” and the sub-sentence “In parallel task 2, when reordering was finished”. The workflow pattern corresponding to the pattern keyword “if” is a conditional pattern, and the workflow pattern corresponding to the pattern keyword “parallel task” is a parallel pattern; then, it is determined that the at least one workflow pattern of the input text includes a conditional pattern and a parallel pattern.

In S2, for each workflow pattern of the at least one workflow pattern, at least one of the following processing method 1 and processing method 2 is performed on the second sub-sentence group to obtain the first sub-sentence group.

In the processing method 1, if no sub-sentence for indicating a boundary of the workflow pattern exists in the second sub-sentence group, the workflow pattern boundary indicating sentence of the workflow pattern is inserted into the second sub-sentence group.

It will be understood that the workflow pattern boundary indicating sentence may be a sub-sentence indicating the start of the workflow pattern or a sub-sentence indicating the end of the workflow pattern. In the embodiments of the present disclosure, the pattern keyword is determined based on one or more sub-sentences. For example, the conditional pattern in the above example is determined based on the sub-sentence “If condition A, add a parallel processor”. For convenience of description, the sub-sentences used to determine the pattern keywords are called pattern sub-sentences in the following embodiments.

Optionally, after the at least one workflow pattern is determined as described above, a search may be performed based on the pattern keyword to determine whether there is a sub-sentence indicating a boundary of each workflow pattern in the second sub-sentence group. For example, a search is performed on sub-sentence(s) before the pattern sub-sentence to determine whether there is a sub-sentence related to the start of the workflow pattern, and a search is performed on sub-sentence(s) after the pattern sub-sentence to determine whether there is a sub-sentence related to the end of the workflow pattern.

For example, for the second sub-sentence group in the above example, it is determined in the above embodiments that the workflow pattern of the second sub-sentence group includes a conditional pattern and a parallel pattern. As for the conditional pattern, its pattern keyword is “if”, and the sentence (i.e., pattern sub-sentence) where the pattern keyword is located is “If condition A, add a parallel processor” and “If condition B, convert the data to the required format”. Before these two sub-sentences, a sub-sentence related to the start of the conditional pattern is found through searching, which is “Add a Condition processor”; and after these two sub-sentences, a sub-sentence related to the end of the conditional pattern is found through searching, which is “Merge the results of the router branches”. That is, the second sub-sentence group includes workflow pattern boundary indicating sentences of the conditional pattern. As for the parallel pattern, the pattern keyword is “parallel task”, and the sentence where the pattern keyword is located is “In parallel task 1, add splitter processor” and “In parallel task 2, when sorting was finished”. Before these two sub-sentences, a sub-sentence related to the start of the parallel pattern is found through searching, which is “add a parallel processor”; and after these two sub-sentences, a sub-sentence related to the end of the parallel pattern is found through searching, which is “After that merges the parallel processing branches”. That is, the second sub-sentence group includes workflow pattern boundary indicating sentences of the parallel pattern.

For any workflow pattern in the at least one workflow pattern, if there is a sub-sentence indicating the boundary of the workflow pattern in the second sub-sentence group, the second sub-sentence group will not be processed; if there is no sub-sentence indicating the boundary of the workflow pattern in the second sub-sentence group, a sub-sentence indicating the boundary of the workflow pattern, i.e., a workflow pattern boundary indicating sentence, is inserted into the second sub-sentence group.

In the process of inserting workflow pattern boundary indicating sentences into the second sub-sentence group, if there is no sub-sentence indicating the start of the workflow pattern in the second sub-sentence group, a workflow pattern boundary indicating sentence indicating the start of the workflow pattern is inserted at a certain position before the pattern sub-sentence; if there is no sub-sentence indicating the end of the workflow pattern in the second sub-sentence group, a workflow pattern boundary indicating sentence indicating the end of the workflow pattern is inserted at a certain position after the pattern sub-sentence. The position where the workflow pattern boundary indicating sentence is inserted is related to the context of the second sub-sentence group.

For the input text 1 of the above example, the second sub-sentence group is obtained after the input text 1 is processed. In a case where the processing method 1 is adopted for processing, since there are sub-sentences for indicating the boundaries of the workflow pattern in the second sub-sentence group, there is no need to insert workflow pattern boundary indicating sentences. Therefore, the result of processing the second sub-sentence group according to processing method 1 is still the second sub-sentence group, which is used as the first sub-sentence group.

In the processing method 2, if no sub-sentence serving as the workflow pattern indicator exists in the second sub-sentence group, the workflow pattern indicator of the workflow pattern is inserted into the second sub-sentence group.

In some embodiments of the present disclosure, the workflow pattern indicator is a sub-sentence used to indicate the type of workflow pattern and the boundary of the workflow pattern. For example, for the conditional pattern, the workflow pattern indicator may be “Create a conditional branch”; and for the parallel pattern, the workflow pattern indicator may be “Create a parallel task branch”.

Based on the above description of the pattern sub-sentence in the processing method 1, in the embodiments of the present disclosure, the method of determining whether there is a sub-sentence that can be used as a workflow pattern indicator in the second sub-sentence group may be to determine whether the pattern sub-sentence itself is a workflow pattern indicator or not. If the pattern sub-sentence is a workflow pattern indicator, there is no need to process the second sub-sentence group. If the pattern sub-sentence is not a workflow indicator, a corresponding workflow pattern indicator needs to be inserted before the pattern sub-sentence.

Still with the second sub-sentence group of the above example as an example, according to the description of the above embodiments, it can be known that the pattern sub-sentences in the second sub-sentence group are respectively:
“If condition A, add a parallel processor.
If condition B, convert the data to the required format.
In parallel task 1, add splitter processor.
In parallel task 2, when reordering was finished.”

None of the above four pattern sub-sentences are workflow pattern indicators. Therefore, corresponding workflow pattern indicators need to be inserted before these pattern sub-sentences.

For example, after the workflow pattern indicators (“Create a conditional branch” and “Create a parallel task branch”) are inserted into the second sub-sentence group, the resulting first sub-sentence group is:
“After the scheduler is triggered. Connect to MySQL database. Add a Condition processor. Create a conditional branch. If condition A, add a parallel processor. Create a parallel task branch. In parallel task 1, add splitter processor. Add a filter processor. Send the output to Oracle database. Create a parallel task branch. In parallel task 2, when sorting was finished. Send the data to DB2. After that merges the parallel processing branches. Create a conditional branch. If condition B, convert the data to the required format. Send the output to PostgreSQL. Merge the results of the router branches. Finally, send notification through SMN service.”

In some embodiments of the present disclosure, the first sub-sentence group obtained through S403 includes sub-sentences arranged in an order in which the process of the task occurs, workflow pattern boundary indicating sentences and workflow pattern indicators. The first sub-sentence group contains some elements for generating the workflow.

In S404, a workflow label corresponding to each sub-sentence in the first sub-sentence group is determined.

The workflow labels corresponding to the plurality of sub-sentences in the first sub-sentence group include a first workflow label for indicating a workflow component or a second workflow label for indicating a workflow pattern. It will be understood that the workflow labels are simplified representation of workflow components and workflow patterns, and the workflow labels are used to generate a workflow.

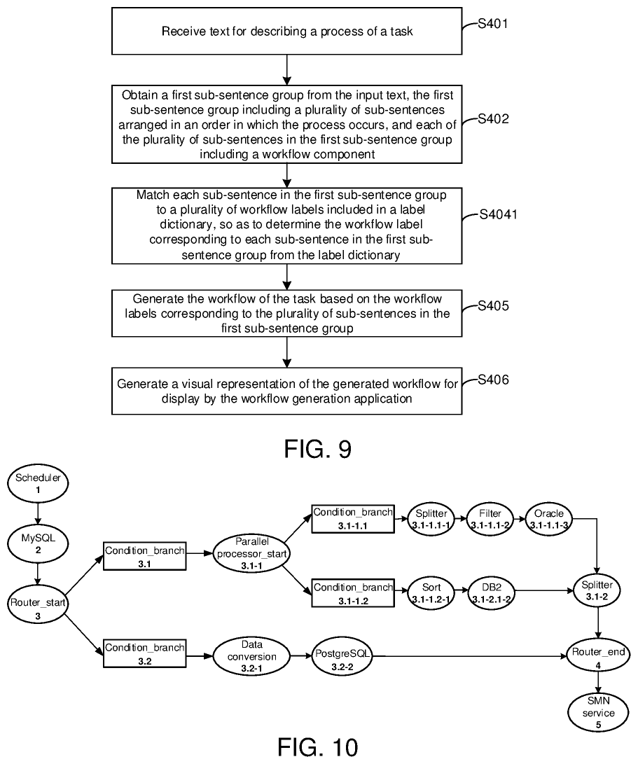

In some embodiments of the present disclosure, a workflow label matching method may be used to match a corresponding workflow label for each sub-sentence in the first sub-sentence group. For example, referring to FIGS. 4 and 9, the above S404 may be implemented through S4041.

In S4041, each sub-sentence in the first sub-sentence group is matched to a plurality of workflow labels included in a label dictionary, so as to determine the workflow label corresponding to each sub-sentence in the first sub-sentence group from the label dictionary.

In some embodiments, a label dictionary for workflow label matching may be created in advance. The label dictionary includes a plurality of workflow labels and predefined values corresponding to the workflow labels. The predefined values are based on workflow components or workflow patterns. That is, in the label dictionary, the workflow label is the “key” and the predefined value is the “value”. The label dictionary is related to the input text to be processed in the embodiments of the present disclosure, and the label dictionary includes all workflow components and workflow patterns of the input text.

In some examples, the above S4041 includes S4041a and S4041b.

In S4041a, semantic similarity processing is performed to match each sub-sentence in the first sub-sentence group to the pre-defined values in the label dictionary.

In some embodiments of the present disclosure, the semantic similarity detection technology is used to perform similarity matching between the sub-sentences and the predefined values in the label dictionary to obtain multiple similarity scores. Optionally, the semantic similarity detection method may be a similarity calculation method based on cosine similarity or Euclidean distance, etc., which is selected according to actual needs, and is not limited in the embodiments of the present disclosure.

In S4041b, a workflow label corresponding to a pre-defined value with a highest similarity score with respect to the sub-sentence in the pre-defined values is determined as the workflow label corresponding to the sub-sentence.

That is, the workflow label corresponding to the predefined value with the highest similarity to the sub-sentence is the workflow label matching the sub-sentence.

To sum up the above S4041a and S4041b, it can be seen that in the embodiments of the present disclosure, the method of indirect semantic similarity detection is used for labeling the sentences. That is to say, instead of directly matching sub-sentences with workflow labels, which is originally a multi-class classification task, the sub-sentences are matched with the predefined values first, and then the workflow label corresponding to the predefined value matched with the sub-sentence is used as the workflow label corresponding to the sub-sentence. Since there are a large number of workflow labels of many types, the process of directly matching sub-sentences with workflow labels is computationally intensive, slow and has low accuracy of matching results, in the embodiments of the present disclosure, an indirect method, which is faster and more accurate, is adopted to match sub-sentences to workflow labels.

For example, for the first sub-sentence group in the above example, the workflow labels matched for each sub-sentence in the first sub-sentence group are as shown in Table 3 below.

TABLE 3

| Sub-sentences in the first | |
|---|---|
| sub-sentence group | Workflow label |
| After the scheduler is triggered. | Scheduler |
| Connect to MySQL database. | MySQL |
| Add a Condition processor. | Router_start |
| Create a conditional branch | Condition_branch |
| If condition A, add a parallel | Parallel processor_start |
| processor. | |
| Create a parallel task branch | Parallel_branch |
| In parallel task 1, add splitter | Splitter |
| processor. | |
| Add a filter processor. | Filter |
| Send the output to Oracle database. | Oracle |
| Create a parallel task branch | Parallel_branch |
| In parallel task 2, when reordering | Sort |
| was finished. | |
| Send the data to DB2. | DB2 |
| After that merges the parallel | Parallel processor_end |
| processing branches. | |
| Create a conditional branch | Condition_branch |
| If condition B, convert the data | Data conversion |
| to the required format. | |
| Send the output to PostgreSQL. | PostgreSQL |
| Merge the results of the | Router_end |
| router branches. | |
| Finally, send notification | SMN service |
| through SMN service. | |

In S405, the workflow of the task is generated based on the workflow labels corresponding to the plurality of sub-sentences in the first sub-sentence group.

In some embodiments of the present disclosure, the generated workflow includes workflow labels corresponding to the plurality of sub-sentences in the first sub-sentence group and mark numbers corresponding to the workflow labels, the mark numbers being used to indicate the logic relationship between the workflow labels.

For example, based on the workflow labels corresponding to the plurality of sub-sentences in the first sub-sentence group in the example shown in Table 3 above, the content of the generated workflow is as shown in Table 4 below.

TABLE 4
Workflow
{‘1’: ‘Scheduler’}
{‘2’: ‘MySQL’}
{‘3’: ‘Router_start’}
{‘3.1’: ‘Condition_branch’}
{‘3.1-1’: ‘Parallel processor_start’}
{‘3.1-1.1’: ‘Parallel_branch’}
{‘3.1-1.1-1’: ‘Splitter’}
{‘3.1-1.1-2’: ‘Filter’}
{‘3.1-1.1-3’: ‘Oracle’}
{‘3.1-1.2’: ‘Parallel_branch’}
{‘3.1-1.2-1’: ‘Sort’}
{‘3.1-1.2-2’: ‘DB2’}
{‘3.1-2’: ‘Parallel processor_end’}
{‘3.2’: ‘Condition_branch’}
{‘3.2-1’: ‘Data conversion’}
{‘3.2-2’: ‘PostgreSQL’}
{4’: ‘Router_end’}
{‘5’: ‘SMN service’}

In combination with Table 4, in the mark numbers of the workflow labels in the workflow, the numbers indicate the execution sequence, the symbol ‘.’ represents a branch, and the symbol ‘-’ represents serial connection.

In S406, a visual representation of the generated workflow is generated for display by the workflow generation application.

In some embodiments of the present disclosure, a visualization tool may be used to visually represent the workflow obtained in S405 above, so that the workflow can be displayed and the users can perceive and understand the workflow intuitively. Optionally, the form of the visual representation of the workflow may be a workflow flowchart or other forms, which are not limited by the embodiments of the present disclosure. FIG. 10 is an example of a visual representation of the workflow shown in Table 4 above.

In combination with the above description, in the text processing method provided in the embodiments of the present disclosure, the workflow generation application in the computing device receives the text for describing the process of the task, and uses the text as the input of the workflow generation application. Then, the text is processed to obtain a first sub-sentence group. The first sub-sentence group includes a plurality of sub-sentences arranged in the order in which the process described in the text occurs, and each of the plurality of sub-sentences in the first sub-sentence group includes a workflow component. Further, a workflow label corresponding to each sub-sentence in the first sub-sentence group that can indicate a workflow component or a workflow pattern is determined. Then, based on the workflow labels corresponding to the plurality of sub-sentences in the first sub-sentence group, a workflow of the task is generated; and a visual representation of the generated workflow is generated, so that the workflow generation application on the computing device can display the workflow. The text processing method provided in the embodiments of the present disclosure may convert the text for describing the process of the task into a workflow. Compared with the technical solution which uses a model including encoders and decoders to obtain a human-understandable result similar to human-like language description, the technical solution of the present disclosure may obtain a workflow that is also understandable by humans; and compared with the human-like language description, the workflow is a more concise description. That is, through the text processing method provided in the embodiments of the present disclosure, the text for describing the process of the task may be converted into a concise workflow that can be understood by humans.

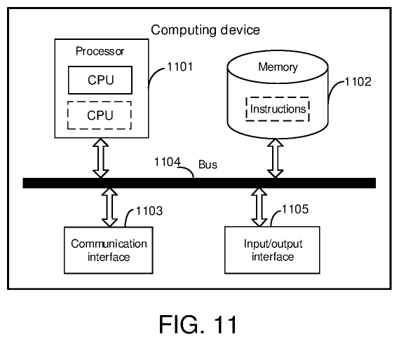

Some embodiments of the present disclosure further provide a computer device for implementing the text processing method described in the above embodiments. FIG. 11 is a structural diagram of a computing device provided in some embodiments of the present disclosure. In some examples, the computing device shown in FIG. 11 is the smart integration engine 101 of the system architecture shown in FIG. 1, and is also the computing device for implementing the method embodiments described in FIGS. 4, 5A, 5B and 9. The computing device includes at least one processor 1101 and a memory 1102.

The processor 1101 includes one or more central processing units (CPUs). The CPU is a single-core CPU (single-CPU) or a multi-core CPU (multi-CPU).

The memory 1102 includes, but is not limited to, random access memory (RAM), read only memory (ROM), erasable programmable read-only memory (EPROM), flash memory, or optical memory. The code of the operating system is stored in the memory 1102.

In some examples, the processor 1101 implements the methods in the foregoing embodiments by reading instructions stored in the memory 1102; or, the processor 1101 implements the method in the foregoing embodiments through internally stored instructions. In the case where the processor 1101 implements the method in the foregoing embodiments by reading the instructions stored in the memory 1102, the memory 1102 stores instructions for implementing the text processing method provided in the embodiments of the present disclosure.

After the program code stored in the memory 1102 is read by the at least one processor 1101, the computing device performs the following operations: receiving, as input to a workflow generation application executing on the computing device, text for describing a process of a task for which a workflow is to be generated; obtaining a first sub-sentence group from the text for describing the process of the task, the first sub-sentence group including a plurality of sub-sentences arranged in an order in which the process occurs, each of the plurality of sub-sentences in the first sub-sentence group including a workflow component, and the workflow component being configured to indicate information of a corresponding functional unit of a plurality of functional units for performing the task; determining a workflow label corresponding to each sub-sentence in the first sub-sentence group, workflow labels corresponding to the plurality of sub-sentences in the first sub-sentence group including a first workflow label for indicating a workflow component or a second workflow label for indicating a workflow pattern; generating a workflow of the task based on the workflow labels corresponding to the plurality of sub-sentences in the first sub-sentence group; and then, generating a visual representation of the generated workflow for display by the workflow generation application.

In some embodiments, the computing device shown in FIG. 11 further includes a communication interface 1103. The communication interface 1103 is a wired interface, for example, a fiber distributed data interface (FDDI) or a gigabit Ethernet (GE) interface. Alternatively, the communication interface 1103 is a wireless interface. The communication interface 1103 is used to receive the text for describing the process of the task. Alternatively, the communication interface 1103 is used to send the generated workflow to a display device or other device.

The memory 1102 is used to store the text received by the communication interface 1103. Optionally, the memory 1102 is also used for training data sets and related AI models. The at least one processor 1101 further executes the method described in the foregoing method embodiments according to the content stored in the memory 1102. For more details on how the processor 1101 implements the functions descried above, reference may be made to the descriptions in the foregoing method embodiments, and details will not be repeated here.

In some examples, the computing device further includes a bus 1104. The processor 1101, the memory 1102, and the communication interface 1103 are usually connected to each other through the bus 1104, or are connected to each other in other ways.

In some examples, the computing device further includes an input/output interface 1105, which is used to connect with an input device and receive the text input by a user. The input device includes but is not limited to a keyboard, a touch screen, a microphone, etc. The input/output interface 1105 is also used to connect with an output device, so as to output the workflow generated by the processor 1101 and display the workflow. The output device includes but is not limited to a monitor, a printer, etc.

The computing device provided in the embodiments of the present disclosure is configured to execute one or more steps in the text processing method provided in any of the above embodiments, so that the text can be converted into a concise workflow that can be understood by humans. It will be noted that, beneficial effects of the computing device are same as those of the text processing method described in some of the above embodiments, and details will not be repeated here.

The above embodiments may be implemented in whole or in part through software, hardware, firmware, or any combination thereof. In a case where the above embodiments are implemented by using a software program, the software program may be implemented in whole or in part in a form of a computer program product. The computer program product includes one or more computer instructions. When loaded and executed on a computer, the computer instructions generate some of all of the processes or functions provided in the embodiments of the present disclosure. The computer may be a general-purpose computer, a dedicated computer, a computer network, or any other programmable device. The computer instructions may be stored in a computer-readable storage medium, or transmitted from one computer-readable storage medium to another computer-readable storage medium. For example, The computer instructions may be transmitted from one website site, computer, server or data center to another website site, computer, server or data center through wired (e.g., coaxial cable, optical fiber, digital subscriber line (DSL)) or wireless (e.g., infrared, wireless, microwave) methods. The computer-readable storage medium may be any available medium that may be accessed by the computer, or a server, a data center or any other data storage device including one or more available media. The available medium may be a magnetic medium (e.g., a floppy disk, a magnetic disk or a magnetic tape), an optical medium (e.g., a digital versatile disk (DVD)), a semiconductor medium (e.g., a solid state drive (SSD)), or the like.

From description of the above embodiments, those skilled in the art will clearly understand that, for convenience and brevity of description, an example is only given according to the above division of functional modules. In practical applications, the above functions may be allocated to different functional modules to be completed as needed. That is, an internal structure of a device may be divided into different functional modules to perform all or part of the functions described above. For the specific working process of the above-described system, device, and unit, reference may be made to the corresponding process in the foregoing method embodiments, and details will not be repeated here.

In several embodiments provided in the present disclosure, it will be understood that the disclosed systems, devices and methods may be implemented through other manners. For example, the device embodiments described above are merely exemplary. For example, the division of the functional modules or units is only a logical functional division. In actual implementation, there may be other division manners. For example, in some embodiments, a plurality of devices or components may be combined or integrated into another system, or some features may be ignored or not executed. In addition, the mutual coupling or direct coupling or communication connection shown or discussed may be an indirect coupling or communication connection through some interfaces, devices or units, and may be an electrical connection, a mechanical connection or other forms of connections.

The units described as separate components may or may not be physically separated, and the components shown as units may or may not be physical units. That is, they may be located in one place, or may be distributed to multiple network units. Some or all of the units may be selected according to actual needs to achieve the purposes of the solutions in the embodiments.

The functional units in the embodiments of the present disclosure may be integrated into a single processing unit; or, the units may be separate physical units; or, two or more units may be integrated into a single unit. The integrated unit may be implemented in the form of hardware, or may be implemented in the form of software functional unit.

If the integrated unit is implemented in the form of software functional unit and sold or used as an independent product, it may be stored in a readable storage medium. Based on this understanding, the technical solution of the present disclosure, in essence, or all or part of the technical solution, may be embodied in the form of a software product. The computer software product is stored in a storage medium, and includes several instructions to cause a computer device (which may be a personal computer, a server, or a network device, etc.) or a processor to execute all or part of the steps of the methods described in various embodiments of the present disclosure. The storage medium includes various types of medium capable of storing program code, such as a USB such as a flash memory, a portable hard disk, a read-only memory (ROM), a random-access memory (RAM), a magnetic disk, or an optical disk.

Some embodiments of the present disclosure provide a computer-readable storage medium (e.g., a non-transitory computer-readable storage medium). The computer-readable storage medium has stored thereon computer program instructions that, when run on a computer, cause the computer to execute one or more steps of the text processing method as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes computer program instructions carried on a non-transitory computer-readable storage medium. When executed on a computer, the computer program instructions cause the computer to perform one or more steps of the text processing method as described in the above embodiments.

Beneficial effects of the computer-readable storage medium and the computer program product are the same as the beneficial effects of the text processing method as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

What is claimed is:

1. A text processing method, performed by a computing device, comprising:
receiving, as input to a workflow generation application executing on the computing device, text for describing a process of a task for which a workflow is to be generated;
obtaining a first sub-sentence group from the text for describing the process of the task, wherein the first sub-sentence group includes a plurality of sub-sentences arranged in an order in which the process occurs, each of the plurality of sub-sentences in the first sub-sentence group includes a workflow component, and the workflow component is configured to indicate information of a corresponding functional unit of a plurality of functional units for performing the task;
determining a workflow label corresponding to each sub-sentence in the first sub-sentence group, wherein workflow labels corresponding to the plurality of sub-sentences in the first sub-sentence group include a first workflow label for indicating a workflow component or a second workflow label for indicating a workflow pattern;
generating the workflow of the task based on the workflow labels corresponding to the plurality of sub-sentences in the first sub-sentence group; and
generating a visual representation of the generated workflow for display by the workflow generation application.

2. The text processing method according to claim 1, wherein obtaining the first sub-sentence group from the text for describing the process of the task includes:
decomposing the text for describing the process of the task to obtain a third sub-sentence group, wherein each of a plurality of sub-sentences included in the third sub-sentence group includes at most one workflow component;
filtering the plurality of sub-sentences in the third sub-sentence group to obtain a fourth sub-sentence group, wherein each of a plurality of sub-sentences included in the fourth sub-sentence group includes one workflow component; and
reordering the plurality of sub-sentences in the fourth sub-sentence group to obtain the first sub-sentence group;
or
obtaining the first sub-sentence group from the text for describing the process of the task includes:
decomposing the text for describing the process of the task to obtain the third sub-sentence group, wherein each of the plurality of sub-sentences included in the third sub-sentence group includes at most one workflow component;
filtering the plurality of sub-sentences in the third sub-sentence group to obtain the fourth sub-sentence group, wherein each of the plurality of sub-sentences included in the fourth sub-sentence group includes one workflow component;
reordering the plurality of sub-sentences in the fourth sub-sentence group to obtain a second sub-sentence group; and
inserting at least one identifier of at least one workflow pattern into the second sub-sentence group to obtain the first sub-sentence group, wherein the at least one workflow pattern is configured to indicate a structure of the process of the task and a relationship between the plurality of functional units.

3. The text processing method according to claim 2, wherein decomposing the text for describing the process of the task to obtain the third sub-sentence group includes:
performing sentence boundary detection on the text to obtain a plurality of sentences of the text; and
splitting, by a first encoder-based model, each of the plurality of sentences of the text into one or more sub-sentences to obtain the third sub-sentence group.

4. The text processing method according to claim 2, wherein filtering the plurality of sub-sentences in the third sub-sentence group to obtain the fourth sub-sentence group includes:
determining, by a second encoder-based model, whether each sub-sentence of the plurality of sub-sentences in the third sub-sentence group includes one workflow component; and
if the sub-sentence in the third sub-sentence group includes zero workflow component, removing the sub-sentence in the third sub-sentence group, so as to obtain the fourth sub-sentence group.

5. The text processing method according to claim 2, wherein reordering the plurality of sub-sentences in the fourth sub-sentence group includes:
reordering, by a third encoder-based model, the plurality of sub-sentences in the fourth sub-sentence group, wherein an input of the third encoder-based model is two sub-sentences in the fourth sub-sentence group, and an output of the third encoder-based model is information for indicating whether an order of the two sub-sentences is correct.

6. The text processing method according to claim 2, wherein an identifier of each workflow pattern of the at least one workflow pattern includes a workflow pattern boundary indicating sentence and/or a workflow pattern indicator; and inserting the at least one identifier of the at least one workflow pattern into the second sub-sentence group to obtain the first sub-sentence group includes:
determining the at least one workflow pattern of the second sub-sentence group;
for each workflow pattern of the at least one workflow pattern, obtaining the first sub-sentence group by performing, on the second sub-sentence group, at least one of the following:
if no sub-sentence for indicating a boundary of the workflow pattern exists in the second sub-sentence group, inserting the workflow pattern boundary indicating sentence of the workflow pattern into the second sub-sentence group; or
if no sub-sentence serving as the workflow pattern indicator exists in the second sub-sentence group, inserting the workflow pattern indicator of the workflow pattern into the second sub-sentence group.

7. The text processing method according to claim 6, wherein determining the at least one workflow pattern of the second sub-sentence group includes:
performing a pattern keyword detection on a plurality of sub-sentences in the second sub-sentence group; and
determining the at least one workflow pattern according to at least one pattern keyword that is detected, wherein each of the at least one pattern keyword is configured to indicate a workflow pattern of the at least one workflow pattern.

8. The text processing method according to claim 1, wherein determining the workflow label corresponding to each sub-sentence in the first sub-sentence group includes:
matching each sub-sentence in the first sub-sentence group to a plurality of workflow labels included in a label dictionary, so as to determine the workflow label corresponding to each sub-sentence in the first sub-sentence group from the label dictionary.

9. The text processing method according to claim 8, wherein the label dictionary further includes pre-defined values corresponding to the plurality of workflow labels; and matching each sub-sentence in the first sub-sentence group to the plurality of workflow labels included in the label dictionary, so as to determine the workflow label corresponding to each sub-sentence in the first sub-sentence group from the label dictionary includes:
performing semantic similarity processing to match each sub-sentence in the first sub-sentence group to the pre-defined values in the label dictionary; and
determining a workflow label corresponding to a pre-defined value with a highest similarity score with respect to the sub-sentence in the pre-defined values as the workflow label corresponding to the sub-sentence.

10. A computing device, comprising:
a memory; and
at least one processor connected to the memory;
wherein the memory is configured to store computer instructions that, when executed by the at least one processor, cause the computing device to implement:
receiving, as input to a workflow generation application executing on the computing device, text for describing a process of a task for which a workflow is to be generated;
obtaining a first sub-sentence group from the text for describing the process of the task, wherein the first sub-sentence group includes a plurality of sub-sentences arranged in an order in which the process occurs, each of the plurality of sub-sentences in the first sub-sentence group includes a workflow component, and the workflow component is configured to indicate information of a corresponding functional unit of a plurality of functional units for performing the task;
determining a workflow label corresponding to each sub-sentence in the first sub-sentence group, wherein workflow labels corresponding to the plurality of sub-sentences in the first sub-sentence group include a first workflow label for indicating a workflow component or a second workflow label for indicating a workflow pattern;
generating a workflow of the task based on the workflow labels corresponding to the plurality of sub-sentences in the first sub-sentence group; and
generating a visual representation of the generated workflow for display by the workflow generation application.

11. The computing device according to claim 10, wherein the computer instructions, when executed by the at least one processor, cause the computing device to implement:
decomposing the text for describing the process of the task to obtain a third sub-sentence group, wherein each of a plurality of sub-sentences included in the third sub-sentence group includes at most one workflow component;
filtering the plurality of sub-sentences in the third sub-sentence group to obtain a fourth sub-sentence group, wherein each of a plurality of sub-sentences included in the fourth sub-sentence group includes one workflow component; and
reordering the plurality of sub-sentences in the fourth sub-sentence group to obtain the first sub-sentence group, or reordering the plurality of sub-sentences in the fourth sub-sentence group to obtain a second sub-sentence group and inserting at least one identifier of at least one workflow pattern into the second sub-sentence group to obtain the first sub-sentence group, wherein the at least one workflow pattern is configured to indicate a structure of the process of the task and a relationship between the plurality of functional unit.

12. The computing device according to claim 11, wherein the computer instructions, when executed by the at least one processor, cause the computing device to implement:
performing sentence boundary detection on the text to obtain a plurality of sentences of the text; and
splitting, by a first encoder-based model, each of the plurality of sentences of the text into one or more sub-sentences to obtain the third sub-sentence group.

13. The computing device according to claim 11, wherein the computer instructions, when executed by the at least one processor, cause the computing device to implement:
determining, by a second encoder-based model, whether each sub-sentence of the plurality of sub-sentences in the third sub-sentence group includes one workflow component; and
if the sub-sentence in the third sub-sentence group includes zero workflow component, removing the sub-sentence in the third sub-sentence group, so as to obtain the fourth sub-sentence group.

14. The computing device according to claim 11, wherein the computer instructions, when executed by the at least one processor, cause the computing device to implement:
reordering, by a third encoder-based model, the plurality of sub-sentences in the fourth sub-sentence group, wherein an input of the third encoder-based model is two sub-sentences in the fourth sub-sentence group, and an output of the third encoder-based model is information for indicating whether an order of the two sub-sentences is correct.

15. The computing device according to claim 11, wherein an identifier of each workflow pattern of the at least one workflow pattern includes a workflow pattern boundary indicating sentence and/or a workflow pattern indicator; and the computer instructions, when executed by the at least one processor, cause the computing device to implement:
determining the at least one workflow pattern of the second sub-sentence group;
for each workflow pattern of the at least one workflow pattern, obtaining the first sub-sentence group by performing, on the second sub-sentence group, at least one of the following:
if no sub-sentence for indicating a boundary of the workflow pattern exists in the second sub-sentence group, inserting the workflow pattern boundary indicating sentence of the workflow pattern into the second sub-sentence group; or
if no sub-sentence serving as the workflow pattern indicator exists in the second sub-sentence group, inserting the workflow pattern indicator of the workflow pattern into the second sub-sentence group.

16. The computing device according to claim 15, wherein the computer instructions, when executed by the at least one processor, cause the computing device to implement:
performing a pattern keyword detection on a plurality of sub-sentences in the second sub-sentence group; and
determining the at least one workflow pattern according to at least one pattern keyword that is detected, wherein each of the at least one pattern keyword is configured to indicate a workflow pattern of the at least one workflow pattern.

17. The computing device according to claim 10, wherein the computer instructions, when executed by the at least one processor, cause the computing device to implement:
matching each sub-sentence in the first sub-sentence group to a plurality of workflow labels included in a label dictionary, so as to determine the workflow label corresponding to each sub-sentence in the first sub-sentence group from the label dictionary.

18. The computing device according to claim 10, wherein the label dictionary further includes pre-defined values corresponding to the plurality of workflow labels; and the computer instructions, when executed by the at least one processor, cause the computing device to implement:
performing semantic similarity processing to match each sub-sentence in the first sub-sentence group to the pre-defined values in the label dictionary; and
determining a workflow label corresponding to a pre-defined value with a highest similarity score with respect to the sub-sentence in the pre-defined values as the workflow label corresponding to the sub-sentence.

19. A non-transitory computer-readable storage medium having stored computer instructions thereon, wherein when executed by a computer, the computer instructions cause the computer to implement:
receiving, as input to a workflow generation application executing on the computing device, text for describing a process of a task for which a workflow is to be generated
obtaining a first sub-sentence group from the text for describing the process of the task, wherein the first sub-sentence group includes a plurality of sub-sentences arranged in an order in which the process occurs, each of the plurality of sub-sentences in the first sub-sentence group includes a workflow component, and the workflow component is configured to indicate information of a corresponding functional unit of a plurality of functional units for performing the task;
determining a workflow label corresponding to each sub-sentence in the first sub-sentence group, wherein workflow labels corresponding to the plurality of sub-sentences in the first sub-sentence group include a first workflow label for indicating a workflow component or a second workflow label for indicating a workflow pattern;
generating a workflow of the task based on the workflow labels corresponding to the plurality of sub-sentences in the first sub-sentence group; and
generating a visual representation of the generated workflow for display by the workflow generation application.

20. The non-transitory computer-readable storage medium according to claim 19, wherein when executed by a computer, the computer instructions cause the computer to implement:
decomposing the text for describing the process of the task to obtain a third sub-sentence group, wherein each of a plurality of sub-sentences included in the third sub-sentence group includes at most one workflow component;
filtering the plurality of sub-sentences in the third sub-sentence group to obtain a fourth sub-sentence group, wherein each of a plurality of sub-sentences included in the fourth sub-sentence group includes one workflow component; and
reordering the plurality of sub-sentences in the fourth sub-sentence group to obtain the first sub-sentence group, or reordering the plurality of sub-sentences in the fourth sub-sentence group to obtain a second sub-sentence group and inserting at least one identifier of at least one workflow pattern into the second sub-sentence group to obtain the first sub-sentence group, wherein the at least one workflow pattern is configured to indicate a structure of the process of the task and a relationship between the plurality of functional units.
